(19) United States
(12) Patent Application Publication
(10) Pub. No.: US 2007/0111748 A1
(43) Pub. Date: May 17, 2007

(54) Wireless coverage assurance method and apparatus

(76) Inventor: Pankaj Risbood, Bangalore (IN)

Correspondence Address: Lucent Technologies Inc.;Docket Administrator - Room 3J-219, 101 Crawfords Corner Road, Holmdel, NJ, 07733-3030, US

(21) Appl. No.: 11/273,561

(22) Filed: Nov. 14, 2005

(51) Int. Cl. H04M 1/00

(52) U.S. Cl. 455/550.1; 455/456.1; 455/423

(57) ABSTRACT

A method and apparatus for monitoring a wireless subscriber's perception of the quality of service (QoS) parameters of a wireless network and correlate such perception to an actual location in a coverage area within the network for assuring and improving QoS parameters.

### FIELD OF THE INVENTION

The present invention relates generally to the monitoring of quality of service (“QoS”) in wireless communications networks and, more specifically, to a technique for monitoring wireless communications service parameters, together with location information, in a dynamic fashion utilizing location-enabled mobile devices.

### BACKGROUND OF INVENTION

The current adoption and use of a variety of mobile devices by users is widespread. For example, mobile wireless telecommunications systems are rapidly replacing the delivery of services once solely provided by conventional wire-line telecommunications systems. In particular, an increasing number of cellular telephone subscribers rely solely on their mobile cellular telephone as their primary voice (and data) connection and no longer subscribe to a traditional wire-line (i.e., a well-known POTS line) service. Wireless cellular communications is well-known and the art is replete with descriptions thereof, for example, U.S. Pat. No. 5,204,902, which is hereby incorporated for reference, so the details of such cellular communications will be dispensed with herein. As wireless services advance in number and complexity, the processing power and capabilities of current mobile telephones is expanding to take advantage of the advanced service offerings from wireless communications service providers.

Of course, competition among wireless service providers for subscribers to their various service offerings is intense given the widespread availability of mobile telephones and the variety of available services. As such, wireless service providers are constantly looking for ways to distinguish their wireless network and associated service offerings from that of their competition. An important differentiator employed by such wireless service providers is on the basis of certain QoS features, in particular, coverage, capacity and reliability. Commonly, wireless service providers employ generally accepted engineering predictive and modeling tools (e.g., tools used to measure radio frequency transmissions from cellular base stations) to ascertain and report rate and coverage maps specific to their wireless networks. Such modeling tools account for factors such as terrain, weather, and antenna characteristics to predict wireless coverage of their networks.

In conjunction with such modeling, the wireless services providers also employ so-called “drive test” measurements whereby the service providers deploy periodic actual drive tests around and through their wireless network to assess the service quality of the network by measuring signal strength, loss, errors, delay and jitter. The drive test results, in combination with the aforementioned predictive models, are typically employed by the wireless service provider to publish so-called “coverage maps” to the general public in an effort to distinguish their network's performance over their competitors. While these drive test/predictive models provide useful depictions of coverage maps for a network, these types of measurement techniques present certain limitations in terms of reporting actual, real-time service quality perceived by individual subscribers. In particular, the following highlight some of these limitations: (1) data is not exhaustive in that the drive test only captures the conditions observed on pre-selected test roadways and not in other locations where subscribers spend a significant amount of time (e.g., office buildings, home locations, outdoor venues, to name just a few); (2) the drive test data represents a “snapshot” in time and may not correspond to the service levels delivered to a subscriber at a given location on a given day at a particular time; (3) depending upon the frequency of drive tests performed, the effects of service parameters such as weather conditions and RF system performance may not be captured; and (4) the overall perception of real-time service quality is not captured on the basis of an actual subscriber's perspective.

Therefore, it would be desirable to have a way to monitor a wireless subscriber's real-time perception of the QoS parameters of a wireless communications network and correlate such perception to an actual location in a coverage area within the network for assuring and improving QoS in terms of coverage, capacity and reliability.

### SUMMARY OF THE INVENTION

Accordingly, the principles of the invention are directed to a method and apparatus for monitoring a wireless subscriber's real-time perception of the QoS parameters of a wireless network and correlating such perception to an actual location in a coverage area within the network for assuring and improving QoS.

More particularly, the various aspects of the present invention are directed to utilizing a location-enabled mobile telephone (for example, a GPS-enabled mobile telephone) having a software agent (in the form of a so-called “wireless coverage assurance application”) installed thereon for gathering data on one or more QoS parameters (e.g., signal strength, service quality, loss, errors, delay and jitter) related to a wireless communications network together with certain location attributes. The wireless coverage application program is a series of program instructions that, upon execution, provides software agent capabilities to the mobile telephone for directly monitoring and collecting certain QoS parameters. In accordance with the aspects of the invention, the location-enabled mobile phone can collect information with regard to the relevant QoS parameters on a continual or periodic basis, or collect the information in the event of a certain trigger condition (e.g., a deteriorating signal strength or dropped calls). In accordance with a preferred embodiment of the invention, the location-enabled device is a GPS-enabled mobile phone that transmits the collected QoS information, together with data as to the mobile phone's actual location, to a server residing within the particular wireless communications network such that the server collects such QoS information from multiple such GPS-enabled mobile phones to ascertain, in real-time, the state of the wireless network at any give time.

Advantageously, the simultaneous collection of the QoS information and location information, directly from the location-enabled mobile device, in accordance with the principles of the invention, at substantially the same time (i.e., seconds or minutes apart) allows for the real-time QoS parameter information to be used to generate coverage maps, trigger early warnings for a failed or failing network component or to fill holes in the coverage area, to name just a few possibilities. Further, the location determination by the GPS-enabled mobile device of the preferred embodiment of the invention is accomplished independent from any communications network that such device is associated with for handling wireless communications exchanged by the device. That is, the GPS-enabled mobile device does not have to rely on information from, or be in communication with, the communications network (e.g., a wireless communications network) to obtain the present location information.

The data collected by the software agent need not be transmitted to the server immediately upon collection. Thus, in alternative embodiments of the invention the collected QoS parameter information is stored locally on the mobile device and transmitted to the server at some later time (e.g., under low load conditions). As such, the wireless network is not overloaded in order to obtain more real-time measurements.

These and other objects, features and advantages of the present invention will become apparent to those of ordinary skill in the art from the following detailed description of illustrative embodiments thereof, which is to be read in connection with the accompanying drawings.

### BRIEF DESCRIPTION OF THE DRAWINGS

FIG. 1 shows an illustrative GPS-enabled mobile telephone configured in accordance with the principles of the invention;

FIGS. 2 and 2A show an illustrative mobile communications network arrangement suitable for implementing embodiments of the present invention incorporating the GPS-enabled mobile telephone of FIG. 1; and

FIG. 3 shows a flowchart of illustrative operations for monitoring one or more QoS parameters from the a location-enabled device together with certain location attributes associated with the location-enabled device, in accordance with the principles of the present invention.

### DETAILED DESCRIPTION OF THE INVENTION

The principles of the invention are directed to a method and apparatus for monitoring a wireless subscriber's real-time perception of the QoS parameters of a wireless communications network and correlating such perception to an actual location in a coverage area within the network for assuring and improving QoS. The term “location-enabled” as used herein is intended to include a variety of arrangements in which a mobile device is capable of determining its present location, and should not be construed as requiring any particular type of location enabling arrangement or configuration. For example, the principles of the invention include location-enabled mobile devices that are capable of obtaining their location utilizing a GPS receiver, or by directly approximating their location by triangulating signals, in a well-known manner, from three or more wireless base stations within the device's current communication range. As such, the location determination by the GPS-enabled mobile device of the preferred embodiment of the present invention is accomplished independent from any communications network that such device is associated with. That is, the GPS-enabled mobile device does not have to rely on information from, or be in communication with, the communications network (e.g., a wireless communications network) to obtain the present location information.

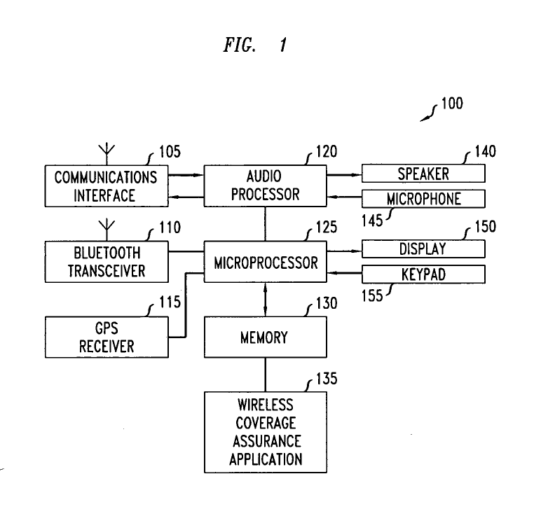

Referring to FIG. 1, an exemplary block diagram of a GPS-enabled mobile telephone 100 configured in accordance with the principles of the invention is shown. While FIG. 1 is directed to a mobile telephone device, as will be appreciated, it is contemplated that the principles of the present invention will be applicable to any location-enabled device such as a personal digital assistant (PDA) or combination PDA/cellular telephone apparatus, to name just a few. In the preferred embodiment of the invention as shown in FIG. 1, GPS-enabled mobile telephone 100 includes microprocessor 125 and memory 130 for controlling the various operational aspects of GPS-enabled mobile telephone 100. Display 150 and keypad 155 work in a conventional manner to provide an interface with the user of GPS-enabled mobile telephone 100. Wireless coverage assurance application 135 is an application program directed to the various aspects of the invention for utilizing a software agent resident on GPS-enabled mobile telephone 100 for the real-time monitoring of a wireless subscriber's perception of the QoS parameters of a wireless network and, correlating such perception to an actual location in a coverage area within the network for assuring and improving QoS as described in greater detail hereinbelow. Essentially, the wireless coverage application program is a series of program instructions that, upon execution, provides software agent capabilities to the mobile telephone for directly monitoring and collecting certain QoS parameters. QoS parameter measurement collection, in accordance with the principles of the invention, involves various modules of the mobile device (e.g., GPS-enabled mobile telephone 100). For example, the wireless communication interface (see, e.g., communications interface 105) consisting of conventional RF and signal processing units is responsible for measuring signal strength, bit errors and network contention. The audio processor (e.g., audio processor 120) is equipped with conventional decoders and buffers for providing input on QoS parameters such as delay, jitter and losses. The wireless coverage assurance application 135 collects the QoS parameter data provided by the various modules of the mobile device and extracts GPS information from the GPS receiver in a conventional manner. As will be well understood, GPS receiver 115 will typically output the location information associated with GPS-enabled mobile telephone 100) which consists of important location attributes such as time, latitude, longitude, speed, etc. in a standard format defined by the well-known NMEA (National Marine Electronics Association). Thereafter, wireless coverage assurance application 135 maps the QoS parameters collected to the location information and time, and stores the information locally on GPS-enabled mobile telephone 100 (e.g., in memory 130) for immediate transmission to a server in the communications network or for a later transmission at a designated time, as described in more detail hereinbelow.

As will be appreciated, while the embodiment of the invention shown in FIG. 1 shows wireless assurance location application 135 (i.e., the software agent) as a standalone application executable by microprocessor 125, it will be understood that in accordance with further embodiments of the invention wireless coverage assurance application 135 may be fully integrated with microprocessor 125 (e.g., firmware) or integrated with an optional Bluetooth transceiver 110 or GPS receiver 115, to name just a few alternatives.

Communications interface 105 enables wireless communication between mobile telephone 100 and a base station in a wireless communications network. Illustratively, communications interface 105 could be configured as a well-known transceiver device for communications with any wireless communications network using, for example, any of the well-known wireless communications standards such as Time Division Multiple Access (TDMA), Code Division Multiple Access (CDMA), Global System for Mobile (GSM) or Universal Mobile Telecommunications System (UMTS). GPS-enabled mobile telephone 100 includes an optional Bluetooth transceiver 110 that provides for conventional Bluetooth communications and capabilities (as set forth in the Bluetooth Core Specification, see, for example, “the Specification of the Bluetooth System”, Volume 0, dated Nov. 5, 2003, as amended, inclusive of Core Package, Version 1.2, available at the Internet site http://www.bluetooth.com). As will be well understood, the Bluetooth system provides a short-range, low power radio communication link for the transfer of voice and data. Bluetooth operates as a universal radio interface in the unlicensed ISM frequency band of 2.4 GHz thereby enabling portable electronic devices to connect and communicate via ad hoc networks.

Audio processor 120 controls the audio processing of signals received through communications interface 105 and routes such processed signals to speaker 140 in a conventional manner. Similarly, audio processor 120 also receives signals from microphone 145 and transfers such received signals to communications interface 105 (e.g., a CDMA transceiver) for broadcast transmission to a base station (e.g., a CDMA base station) in the wireless communications network. GPS receiver 115 enables mobile telephone 100 with conventional GPS capabilities that facilitate the use of GPS-enabled mobile telephone 100 in the collection of QoS parameters in accordance with the invention and the ability to utilize location information (i.e., real-time location of the mobile device) to supplement such QoS parameter collection. As detailed further hereinbelow, the utilization of both the collected QoS parameter information and location information is facilitated, illustratively, by transmitting such information to server 230 or 230-1 that reside in the wireless communications network.

Currently, the wireless communications services industry is experiencing a widespread adoption and the introduction of GPS-enabled devices throughout today's wireless communications networks. It is such widespread adoption of GPS-enabled mobile telephones, that are configured with enhanced overall processing power, that has led the Applicant herein to recognize that QoS techniques can be enhanced by using GPS-enabled mobile devices (or other types of location-enabled mobile devices) in gathering one or more QoS parameters (e.g., signal strength, service quality, loss, errors, delay and jitter) related to a wireless communications network together with certain location attributes associated with the use of the GPS-enabled device by its subscriber. In accordance with the aspects of the invention, the GPS-enabled mobile device can collect information with regard to the relevant QoS parameters, and the simultaneous mobile device location information, on a continual or periodic basis, or collect the information in the event of a certain trigger condition (e.g., a deteriorating signal strength or dropped calls).

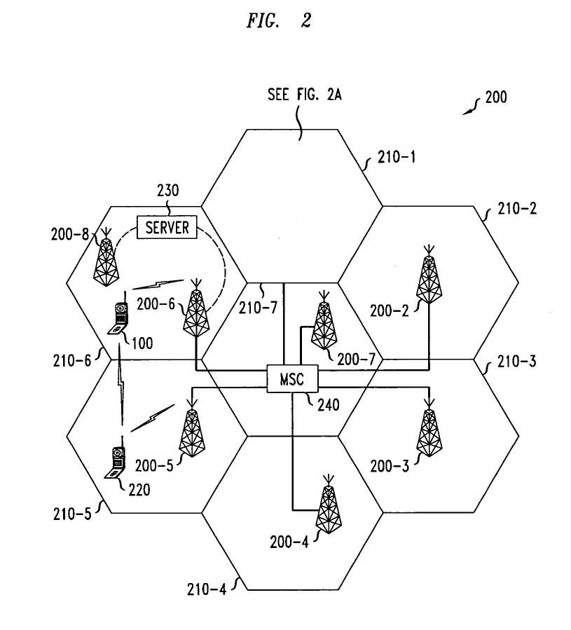

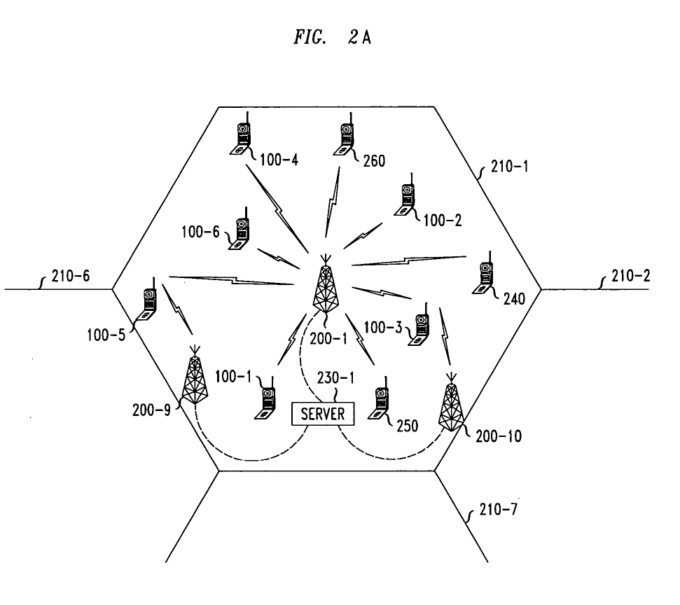

The various aspects of the present invention are further detailed in the following illustrative embodiment. FIGS. 2 and 2A show an illustrative mobile communications network arrangement suitable for implementing embodiments of the present invention incorporating the GPS-enabled mobile telephone of FIG. 1. More particularly, the wireless communications network 200 shown in FIGS. 2 and 2A provides communications services to a variety of subscribers in a geographical area. As shown in FIGS. 2 and 2A, the depicted geographic area of wireless communications network 200 is divided into a plurality of cells 210-1 through 210-7 with each such cell having a at least one corresponding base station 200-1 through 200-10 for enabling wireless communications amongst mobile telephones within a particular cell. Further, each of the base stations 200-1 through 200-10 is connected to a mobile switching center (MSC) 240, which manages the wireless communications network in a well-known fashion, and serves as the communications interface between the wireless communications network and other separate networks (by way of example but not limitation, a public switched telephone network (PSTN)).

As is well-known, the geographic areas serviced by the wireless communications network is divided into a plurality of spatially distinct areas called “cells”. As will be appreciated, while the cells depicted FIGS. 2 and 2A, are show as a hexagon in a honeycomb pattern, each cell is actually of an irregular shape that depends on the topography of the terrain surrounding the cell. It will also be appreciated by one skilled in the art that wireless communications network 200 will have a larger number of cells than as depicted in FIGS. 2 and 2A, which shows a more limited number of cell for purposes of explanation herein. Of course, as will be appreciated, wireless communications network may have other well-known network elements or components such as home location registers (HLR), visitor location registers (VLR), etc., such other well-known network elements or components are not shown in FIGS. 2 and 2A for clarity.

As shown in FIGS. 2 and 2A, cell 210-1 includes base stations 200-1, 200-9 and 200-10 which facilitate wireless communications amongst (i) mobile telephones 100-1 through 100-6, each of which is configured in accordance with the principles of the invention and in accordance with illustrative GPS-enabled mobile telephone 100 (as shown in detail FIG. 1 and shown in cell 210-6 of FIG. 2); and (ii) mobile telephones 220, 240, 250 and 260, each of which are configured in a conventional manner as non-GPS enabled devices. In accordance with the principles of the invention, any one, or any combination, of GPS-enabled mobile telephones 100-1 through 100-6 may be utilized to collect and monitor QoS parameters in accordance with the various aspects of the invention. Thereafter, the collected QoS parameter information, together with location data with respect to the GPS-enabled mobile telephone is sent to a server resident in the wireless communications network, for example, server 230 or 230-1.

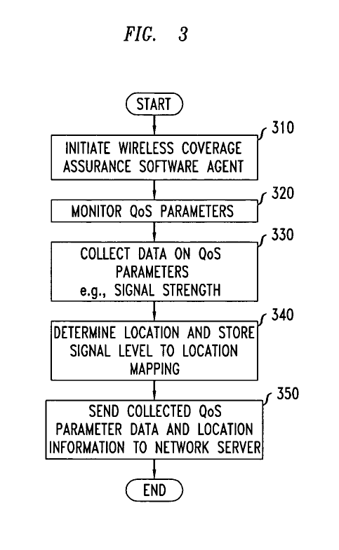

FIG. 3 shows a flowchart of illustrative operations for monitoring one or more QoS parameters from the a location-enabled device together with certain location attributes associated with the location-enabled mobile device, in accordance with the principles of the present invention. Turning our attention to both FIGS. 2A and 3 to facilitate a more complete understanding of the principles of the invention, suppose GPS-enabled mobile telephone 100-5 is to be employed to collect and monitor QoS parameters in accordance with the various aspects of the invention.

In accordance with an aspect of the invention, the wireless assurance coverage application/software agent 135 is initiated in mobile telephone 100-5, as indicated in step 310. Illustratively, such initiation may occur at fixed time intervals or in response to a particular trigger event (e.g., deterioration of signal strength). Also, while the current explanation is in the context of a single GPS-enabled mobile telephone it will be understood that the principles of the invention apply equally to multiple GPS-enabled mobile telephone configurations. The initiation of GPS-enabled mobile telephone, configured in accordance with the principles of the invention, will allow for the measurement and collection of QoS data from, for example, regions of high call volume, high data usage, business customers, residential customers and/or regions under investigation in view of prior monitoring and measurement.

Upon initiation of the software agent, the plurality of QoS parameters that are to be monitored and collected begins, as indicated in steps 320 and 330, respectively. Again, as mentioned previously, the QoS parameters which may be the subject of monitoring and collecting, in accordance with the principles of the invention, include but are not limited to signal strength, service quality, loss, errors, delay and jitter. As the monitoring and collecting of the QoS parameters occurs, in accordance with an aspect of the invention, the actual location of GPS-enabled mobile telephone 100-5 is determined and the signal level is stored to location mapping, as indicated in step 340. In accordance with the preferred embodiment of the invention, the GPS receiver (see, e.g., GPS receiver 115 in FIG. 1) is integrated with the mobile device and will be utilized in determining the GPS-enabled mobile device's location in a conventional manner. As will be well understood, the GPS receiver obtains synchronization with three (3) or more GPS satellites and performs a triangulation to obtain the latitude and longitude of the device's current location. Of course, the accuracy of such location is enhanced when the GPS receiver is able to receive signals from several such GPS satellites. Interfacing with additional GPS satellites also enables the GPS receiver to calculate attributes such as altitude and ground speed. Essentially, the mapping of location to signal level mapping is a table that lists for a given location the observed signal strength and other QoS parameters monitored in accordance with the principles of the invention.

Advantageously, in accordance with the principles of the invention, the GPS-enabled mobile telephone collects data on the desired QoS parameters together with the mobile telephone's actual location (all in real-time). In accordance with the various aspects of the invention, the location information is determined at substantially the same time as the monitoring and/or collecting of the QoS parameter information. As such, the combination of the QoS parameter data and location information will provide critical information to the wireless network service provider in the operation of its wireless communications network. Thus, GPS-enabled mobile telephone 100-5 sends the collected QoS parameter data and its location to a server resident in the wireless communications network (e.g., server 230-1), as indicated in step 350.

In accordance with various embodiments of the invention, the collected QoS parameter data and location information can be transmitted by the GPS-enabled mobile telephone to the server in accordance with any number of well-known communications protocols. For example, in wireless communications networks employing well-known wireless communications standards such as 1×RTT, UMTS and EV-DO, which support native data transport, the GPS-enabled mobile telephone can connect directly to the resident server using the well-known HTTP or TCP/IP protocols, and with conventional authentication and encryption can upload the data. In other embodiments of the invention in which only circuit switching is supported, the GPS-enabled mobile telephone can establish a direct connection to the server and then upload the data. The actual format of the data can be in any number of well-known formats that will be readily apparent to those skilled in the art, for example, the QoS parameter data could simply be transmitted as a set of records in the form “<name, value>” or in the well-known XML format. Typically, the data will be compressed and encrypted in a conventional manner to conserve bandwidth and improve the security of the transmission. In accordance with the various embodiments of the invention, the resident server (e.g., server 230 or 230-1) is a well-known Web/FTP server that allows mobile devices to upload data in the form of files, and that will execute (in a conventional manner) a variety of applications such as data extraction, parsing, databases, data mining and algorithms for data analysis.

Upon receiving the QoS parameter data and location information from the GPS-enabled mobile telephone, the wireless communications network administrator will be able to utilize the data to generate coverage maps of the wireless network. That is, the aforementioned servers in conjunction, illustratively, with well-known sampling routines and data analysis and mining engines will allow for the analysis of the QoS parameter information, in combination with the mobile device location information, to study and/or improve network performance. Further, comparisons may be made over time for a particular region to identify high variances of service quality or deteriorating performance over time. Also, maintenance alarms may be generated (e.g., a failing network RF subsystem) to allow for problem resolution prior to any perceptible degradation in network service quality by the subscriber.

The foregoing merely illustrates the principles of the invention. It will thus be appreciated that those skilled in the art will be able to devise various arrangements which, although not explicitly described or shown herein, embody the principles of the invention and are within its spirit and scope. For example, one skilled in the art, in light of the descriptions of the various embodiments herein, will recognize that the principles of the present invention may be utilized in widely disparate fields and applications. All examples and conditional language recited herein are intended expressly to be only for pedagogical purposes to aid the reader in understanding the principles of the invention and are to be construed as being without limitation to such specifically recited examples and conditions. Moreover, all statements herein reciting aspects and embodiments of the invention, as well as specific examples thereof, are intended to encompass functional equivalents thereof.

Further, the invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The invention can also be embodied in the form of program code, for example, in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

I claim:

1. A GPS-enabled mobile communications apparatus, said GPS-enabled mobile communications apparatus comprising:
a GPS receiver;
a memory for storing a wireless coverage assurance application, said wireless coverage assurance application having at least a plurality of program instructions; and
a processor for executing said plurality of program instructions and for controlling the operation of said mobile communications apparatus in accordance with the functions defined by the plurality of program instructions, the plurality of program instructions defining the steps of:
(i) monitoring a plurality of quality of service (QoS) parameters of a wireless communications network in which said GPS-enabled mobile communications apparatus is communicating;
(ii) collecting data with respect to said monitored QoS parameters;
(iii) determining, utilizing said GPS receiver, a location of said GPS-enabled mobile communications apparatus; and
(iv) transmitting said collected QoS parameter data and said location to a server associated with said wireless communications network.

2. The GPS-enabled mobile communications apparatus of claim 1, wherein said monitoring is initiated by a request from said server and received by said GPS-enabled mobile communications apparatus.

3. The GPS-enabled mobile communications apparatus of claim 1, wherein said plurality of QoS parameters include at least a signal strength and a service quality parameter associated with said communicating by said GPS-enabled mobile communications apparatus in said wireless communications network.

4. The GPS-enabled mobile communications apparatus of claim 1, wherein said GPS-enabled mobile communications apparatus is a cellular telephone.

5. The GPS-enabled mobile communications apparatus of claim 4, wherein said monitoring is initiated by said GPS-enabled mobile communications apparatus at a fixed time interval.

6. The GPS-enabled mobile communications apparatus of claim 4, wherein said collecting step includes the further step of:
storing said collected QoS parameter data in a memory integral with said cellular telephone.

7. The GPS-enabled mobile communications apparatus of claim 3, wherein said location is determined at substantially the same time as said monitoring of said plurality of QoS parameters.

8. The GPS-enabled mobile communications apparatus of claim 1, wherein said wireless coverage assurance application serves as a software agent upon execution.

9. A method of operating a location-enabled mobile communications apparatus for monitoring and collecting data with respect to a plurality of QoS parameters associated with a wireless communications network, said method comprising:
monitoring said plurality of QoS parameters of said wireless communications network in which said location-enabled mobile communications apparatus is communicating;
collecting said data with respect to said monitored QoS parameters;
determining, by said location-enabled mobile communications apparatus, a location of said location-enabled mobile communications apparatus; and
transmitting said collected QoS parameter data and said location to said wireless communications network.

10. The method of claim 9, wherein said collected QoS parameter data is transmitted to a server associated with said wireless communications network.

11. The method of claim 10, wherein said server utilizes said collected QoS parameter data to generate a coverage map of said wireless communications network.

12. The method of claim 10, wherein said monitoring is initiated by a request from said server to said location-enabled mobile communications apparatus.

13. The method of claim 11, wherein said location-enabled mobile communications apparatus is a cellular telephone having a GPS receiver for use in said determining of said location.

14. The method of claim 13, wherein said collecting step includes the further step of:
storing said collected QoS parameter data in a memory integral with said cellular telephone.

15. The method of claim 13, wherein said monitoring is initiated by said cellular telephone as a function of a trigger event.

16. The method of claim 15, wherein said trigger event is a deterioration in signal strength received by said cellular telephone.

17. The method of claim 12, wherein location is determined at substantially the same time as said monitoring of said plurality of QoS parameters.

18. A method of operating a server associated with a wireless communications network, said method comprising:
receiving a communication from at least one GPS-enabled mobile communications apparatus, said communication including a plurality of QoS parameters associated with said wireless communications network, said plurality of QoS parameters having been monitored and collected directly by said GPS-enabled mobile communications apparatus; and
analyzing at least one QoS parameter of said plurality of QoS parameters.

19. The method of claim 18, further comprising the step of
generating, as a function of particular ones of said QoS parameters, a coverage map associated with said wireless communications network.

20. The method of claim 18, further comprising the step of initiating a warning signal to said wireless communications network, said warning signal indicative of at least one failing subsystem within said wireless communications network.
